(19) United States
(12) Patent Application Publication
(10) Pub. No.: US 2010/0239465 A1
(43) Pub. Date: Sep. 23, 2010

(54) Fluorescence Sensor for Detecting Gas Compositions

(75) Inventors: Thomas Becker, Ottobrunn (DE); Ilker Sayhan, Munich (DE)

Correspondence Address: CROWELL & MORING LLP;INTELLECTUAL PROPERTY GROUP, P.O. BOX 14300, WASHINGTON, DC, 20044-4300, US

(73) Assignee: EADS DEUTSCHLAND GmbH, Ottobrunn (DE)

(21) Appl. No.: 12/302,767

(22) PCT Filed: May 8, 2007
(86) PCT No.: PCT/DE07/00820

§ 371 Date: Mar. 3, 2009

(30) Foreign Application Priority Data
May 30, 2006 (DE) 10 2006 025 470.8

(51) Int. Cl. G01N 21/64

(52) U.S. Cl. 422/86

(57) ABSTRACT

A fluorescent sensor for the detection of gas compositions has a carrier substrate and a fluorescent layer. The carrier substrate and fluorescent layer consists of a gas-permeable polymer matrix with an embedded fluorescent dye. A diffusion layer of gas-permeable ceramics and/or polymers is arranged over the fluorescent layer and is adapted to cause a time delay of the gas diffusion from a detected-environment to the fluorescent layer and from the fluorescent layer to a detected-environment.

### RELATED APPLICATIONS

This application is a U.S. National Stage under 35 U.S.C. §371 of International Patent application no. PCT/DE2007/000820, filed May 8, 2007, and claims priority to German Patent application no. DE 10 2006 025 470.8, filed May 30, 2006. The disclosures of each of these applications are incorporated by reference herein in their entirety.

### BACKGROUND AND DESCRIPTION OF THE INVENTION

The invention relates to a fluorescent sensor for the detection of gas compositions having a carrier substrate and a fluorescent layer, consisting primarily of applied thereto. The carrier substrate and fluorescent layer essentially consist of a gas-permeable polymer matrix with a fluorescent dye embedded therein.

Known fluorescent sensors of the above-mentioned type are constructed such that they preferably react to target gases to be detected in the respective environment. The target gases contain oxygen or NO₂— compounds or mixtures thereof. As a result, explosives, for example, can also be detected. The fluorescence of the sensors is detected by a measuring device mounted at a suitable distance from the fluorescent sensor and is electrically or electronically converted to desired signals in suitable signal generators.

To the extent that signals generated by the fluorescent sensor are to be reproduced differently with respect to time or location than at the detection site, corresponding storage media or at least corresponding transfer devices for the signals must be provided, which, as a rule, is connected with constructional expenditures.

One object of certain embodiments of the present invention is to create a fluorescent sensor whose fluorescence resulting from the detection of a gas composition is maintained for a desired time period, so that a read-out measuring device does not have to be arranged directly at the site of the gas composition to be detected but, after having been moved to a different site or after a desired time period, the fluorescent sensor can transmit the detected gas composition to a read-out measuring device present at that site or at that time.

In the case of a fluorescent sensor for the detection of gas compositions having a carrier substrate and a fluorescent layer applied thereto essentially consisting of a gas-permeable polymer matrix with an a embedded fluorescent dye, this object is achieved, according to one embodiment of the invention, by a diffusion layer of gas-permeable ceramics and/or polymers arranged over the fluorescent layer, wherein said diffusion layer is adapted to cause a time delay of the gas diffusion from the environment to be detected to the fluorescent layer and vice-versa.

To this extent, the gas of the environment that is to measured advances more slowly to the fluorescent layer and, in the same manner, diffuses more slowly away from the fluorescent layer. The gas composition directly over the fluorescent layer is preserved for a certain time, allowing the respectively emitted fluorescence to indicate the gas composition of the environment with a time delay. In this manner, the fluorescent sensor is moved out of the environment to be detected to obtain the gas composition of the detected environment by a suitable read-out lens system. This time delay has the important advantage that the user is enabled to measure the specific fluorescence or to determine the specific gas concentration that corresponds to the preserved condition by a manual measuring instrument.

Depending on the selected parameters of the diffusion layer, the time duration for which the fluorescence is to be stored is calibrated. The diffusion layer is designed such that a storage of the gases takes place within the range of several hours.

In one embodiment of the invention, the fluorescent sensor is configured to be provided on an RFID Tag (radio frequency identification tag), or the like, or on packaging structures or transport structures. In this case the parameters for the diffusion layer on the sensor can easily be configured to permit storage of the gases to take place for several hours directly over the fluorescent layer.

The fluorescent sensor may be integrated, for example, on one or several RFID Tags. An external read-out lens system permits the RFID Tags to be read out, for example, at a distance of several centimeters.

In a preferred embodiment of the invention, the fluorescent sensor has a thickness of between a few μm and several hundred μm. The thickness of the diffusion layer selected as a function of the desired time delay of the gas diffusion.

In another embodiment of the invention, the permeability of the diffusion layer is adjusted with respect to oxygen and/or NO₂ compounds or mixtures thereof. This embodiment is especially advantageous for the detection of explosive compounds.

In yet another embodiment of the invention, ternary oxides is provided as ceramics and SU-8 is provided as polymer for the diffusion layer.

In a further embodiment of invention, several differently reacting fluorescent layers are arranged side-by-side and covered with a diffusion layer. In this manner, gas compositions can be detected according to the most varied gas constituents by using a single fluorescent sensor with the desired time delay.

In yet a further embodiment of the invention, polymers are used as a carrier substrate. Kapton, polyurethane or polyethylene are particularly suitable for this use. However, ceramics and silicon substrates may also be used.

Other objects, advantages and novel features of the present invention will become apparent from the following detailed description of the invention when considered in conjunction with the accompanying drawing.

### BRIEF DESCRIPTION OF THE DRAWING

FIG. 1 represents a schematic view of an embodiment of a fluorescent sensor according to the invention.

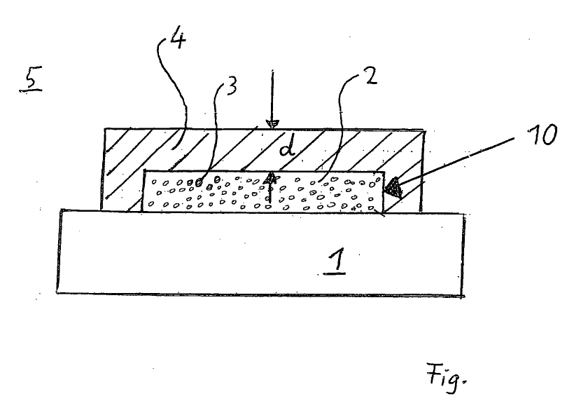

### DETAILED DESCRIPTION OF THE DRAWING

A fluorescent layer 10 is arranged on a carrier substrate 1, which essentially has the shape of a cuboid-shaped plate or of a strip or a band. The fluorescent layer 10 includes, and may be limited to a gas-permeable polymer matrix 2 with a fluorescent dye 3 embedded therein. A gas-permeable diffusion layer 4 of a thickness d is placed directly on the fluorescent layer 10, so that gases acting upon the fluorescent layer 10 from the environment 5 can reach the fluorescent layer 10 only in a delayed manner after their diffusion over the distance d through the diffusion layer. The gas atmosphere in the area of the fluorescent layer 10 is maintained for a longer time period because of the outward diffusion through the diffusion layer 4 back into the environment 5 also occurs in a delayed manner. The diffusion layer 4 is also called a retaining or storage layer corresponding to its effect.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-9. (canceled)

10. A fluorescent sensor for the detection of gas compositions comprising:
a carrier substrate and a fluorescent layer applied thereto, the fluorescent layer consisting essentially of a gas-permeable polymer matrix with an embedded fluorescent dye, wherein
a diffusion layer of gas-permeable comprising at least one of ceramics and polymers is arranged over the fluorescent layer,
the diffusion layer being adapted such that it causes a time delay of gas diffusion from the detected-environment to the fluorescent layer, and
the diffusion layer being adapted such that it causes a time delay of gas diffusion from the fluorescent layer to the detected-environment.

11. The fluorescent sensor according to claim 10, wherein that the thickness of the diffusion layer is between a few μm and several hundred μm.

12. The fluorescent sensor according to claim 11, wherein the thickness of the diffusion layer is selected as a function of the desired time delay of the gas diffusion.

13. The fluorescent sensor according to claim 10, wherein the permeability of the diffusion layer is adjusted with respect to oxygen or NO₂ compounds or mixtures thereof.

14. The fluorescent sensor according to claim 10, wherein ternary oxides are provided as ceramics and SU-8 is provided as polymer for the diffusion layer.

15. The fluorescent sensor according to claim 10, wherein several differently reacting fluorescence layers are arranged side-by-side and are covered by a diffusion layer.

16. The fluorescent sensor according to claim 10, wherein polymers are used as the carrier substrate.

17. The fluorescent sensor according to claim 16, wherein Kapton, PUR or PET is selected for the carrier substrate.

18. The fluorescent sensor according to claim 10, wherein the carrier substrate is configured from at one least material selected from the group consisting of silicon and ceramics.
